(19) United States
(12) Patent Application Publication
(10) Pub. No.: US 2018/0373922 A1
(43) Pub. Date: Dec. 27, 2018

(54) FACIAL GESTURE CAPTCHA

(71) Applicant: Intel IP Corporation, Santa Clara, CA (US)

(72) Inventors: Sirui Yang, Beijing (CN); Yimin Zhang, Beijing (CN)

(21) Appl. No.: 16/062,512

(22) PCT Filed: Dec. 17, 2015
(86) PCT No.: PCT/CN2015/097711

§ 371 Date: Jun. 14, 2018

(51) Int. Cl. G06K 9/00; G06F 21/32; G06F 3/01

(52) U.S. Cl. CPC G06K 9/00281; G06F 21/32; G06F 2221/2133; G06K 9/00597; G06F 3/017; G06K 9/00308

(57) ABSTRACT

Various systems and methods for implementing a facial gesture-based CAPTCHA are described herein. A system for securing a resource comprises a presentation module to present on a display of the system, a facial gesture challenge prompt to a user; an image processor to: obtain an image from a camera coupled to the compute device, the image including a facial expression of the user; and obtain analysis of the image, the analysis to determine whether the facial expression matches the facial gesture challenge prompt; and wherein the presentation module is to provide an indication to the user of whether the facial expression matches the facial gesture challenge prompt.

### TECHNICAL FIELD

Embodiments described herein generally relate to security mechanisms and in particular, to implementing a facial gesture captcha.

### BACKGROUND

CAPTCHA is an acronym for Completely Automated Public Turing test to tell Computers and Humans Apart. CAPTCHAs are used as a challenge-response test to determine whether a user is human One form of CAPTCHA is a text string or number that is partially distorted, obscured, or altered so that machine cannot easily recognize the pass phrase and enter it.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a schematic drawing illustrating a system to implement a facial gesture CAPTCHA, according to an embodiment;

FIG. 2 is a schematic drawing illustrating a system to implement a facial gesture CAPTCHA, according to an embodiment;

FIG. 3 is a schematic diagram illustrating an operating environment, according to an embodiment;

FIG. 4 is an illustration of a coordinate model, according to an embodiment;

FIG. 5 is a flowchart illustrating a method of securing a resource, according to an embodiment; and

FIG. 6 is a block diagram illustrating an example machine upon which any one or more of the techniques (e.g., methodologies) discussed herein may perform, according to an example embodiment.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

Systems and methods described herein implement a facial gesture-based CAPTCHA. Many forms of CAPTCHAs are text-based where a user is prompted with a scrambled, distorted, or otherwise altered string of characters and is expected to enter the correct string in order to access a resource (e.g., navigate to a web page). Other types of CAPTCHAs use a mathematical problem or a photo to quiz the user for a correct response.

One difficulty in designing a CHAPTCHA system is the tradeoff between excluding non-human requests (e.g., automated computer attacks) with difficult requirements and convenience for human users to perform. Also, for mobile platforms, inputting text or selecting images provide extra challenges as there is no physical keyboards and screen area is limited. Using facial gestures, which may be captured by cameras available in many computing devices, as CAPTCHAs is natural for human beings but more difficult for programs or scripts to break. It also adapts to mobile cases better.

As used in this document, a “facial gesture” includes facial and head movements, positions, and expressions that a human being may perform. In general, the document describes a system that provides a description or depiction of a facial gesture as a CAPTCHA challenge. The user then needs to perform the facial gesture in order to pass the CAPTCHA verification. The description or depiction of the facial gesture may be partially deformed, obscured, or otherwise camouflaged to better avoid automatic computer evaluation and analysis. In addition, the description or depiction of the CAPTCHA challenge may be textual, iconic, picture, or a pictograph to provide additional security against computer attacks.

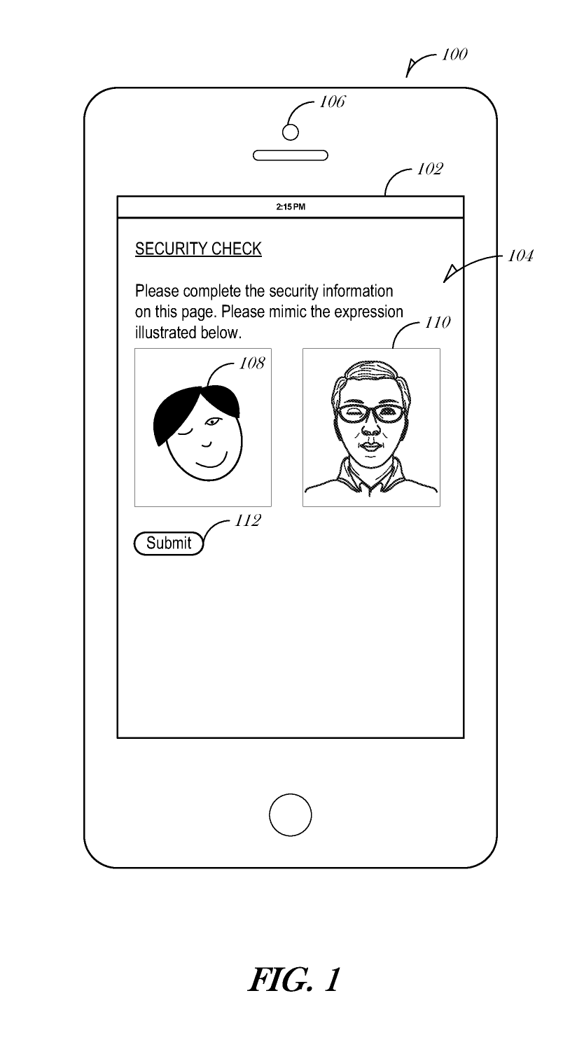

FIG. 1 is a schematic drawing illustrating a system 100 to implement a facial gesture CAPTCHA, according to an embodiment. The system 100 includes a display 102, which presents a user interface 104. The system 100 also includes a camera 106. The camera 106 is a user-facing camera. The system 100 may also include a world-facing camera on the backside of the system 100. The camera 106 may be of any type of camera, including a visible light camera, an infrared camera, a depth camera, or the like.

A facial gesture CAPTCHA challenge 108 is displayed on the user interface 104. A camera image of the user's face is presented in the CAPTCHA response area 110. In the response area 110 the user's face is shown using a video feed from the camera 106. The user may adjust their position relative to the camera 106 and the system 100 to frame their image. The user may then perform the facial gesture illustrated in the CAPTCHA challenge 108. In this example, the facial gesture CAPTCHA challenge 108 includes the compound elements of a wink, a smile, and a head tilt of approximately 20 degrees. The user may be prompted to mirror the CAPTCHA challenge 108; thus, although the CAPTCHA challenge 108 is illustrating a right-eye wink and a head tilt to the model's right, the user may tilt their head to the left and wink their left eye in order to match the CAPTCHA challenge 108. In alternatively embodiments, the user may be required to perform the facial gesture in the manner illustrated with the appropriately adjusted orientation. When the user is satisfied with their facial gesture, the user may activate the submit user interface element 112. Upon activation of the submit user interface element 112, the system 110 captures an image of the user; performs image analysis to determine facial expressions, head tilt, and other aspects of the user's facial gesture; and compares the analyzed user facial gesture against the facial gesture CAPTCHA challenge 108 to determine whether the user passed the security check.

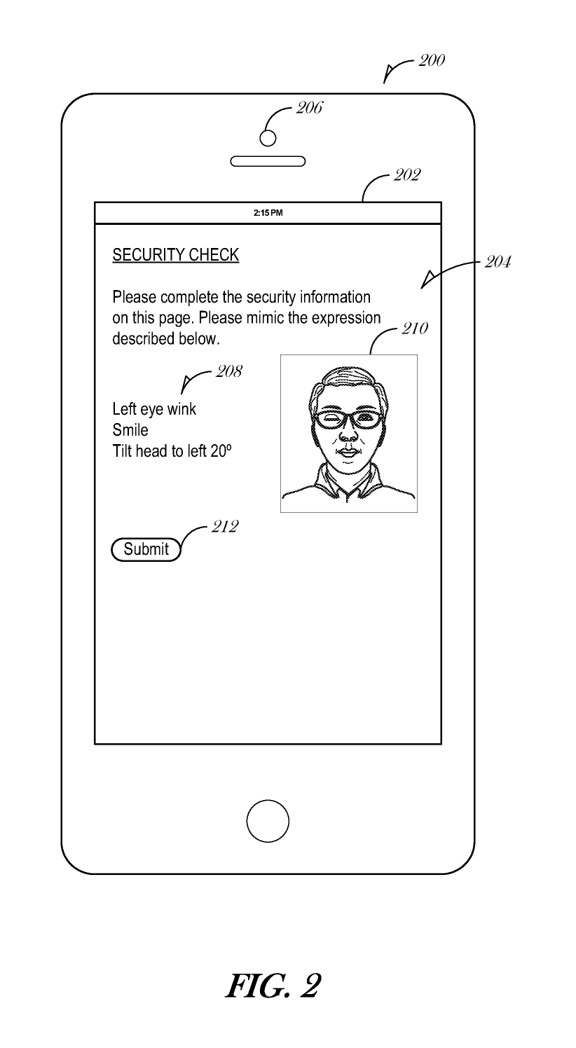

FIG. 2 is a schematic drawing illustrating a system 200 to implement a facial gesture CAPTCHA, according to an embodiment. As with system 100 illustrated in FIG. 1, the system 200 includes similar components of a display 202, a user interface 204, a camera 206, a response area 210, and a submit user interface element 212. In the embodiment depicted in FIG. 2, rather than a pictogram or illustration of the facial gesture CAPTCHA challenge, a textual description 208 is used. The textual description 208 may be obscured or masked in various ways to prevent computer recognition.

The presently disclosed embodiments may be extended to include mechanisms that allow a user to request a different facial gesture CAPTCHA challenge (e.g., 108 or 208). For example, a person without an eye or who is unable to perform certain actions (e.g., facial paralysis due to stroke) may request a different facial gesture CAPTCHA to perform.

Further, the presently disclosed embodiments may be modified to optionally omit the submit user interface element (e.g., 112). In such embodiments, the camera (e.g., 106) captures a video of the user and when the user performs the appropriate facial gesture, the security check is confirmed. A time limit may be used to avoid abuse or hacking attempts.

Further, while the embodiments described in FIGS. 1 and 2 include multiple elements of facial expression, it is understood that the facial gesture CAPTCHA challenge may include a single element (e.g., smile, frown, or wink). The use of multiple elements for the facial gesture CAPTCHA challenge increases the security. In addition, while the embodiments described in FIGS. 1 and 2 include eye position, mouth position, and head tilt, it is understood that these are illustrative and that any element of facial gesture may be used including nose flaring, eyebrow position, forward/backward head tilt, tongue position, or the like.

In order to recognize a facial gesture provided by a user, computer vision techniques are used. An example technique includes the operations of (1) detecting a human face, (2) detecting facial landmarks, (3) retrieving facial gestures with landmark distributions, (4) comparing the user's facial gesture with the desired facial gesture, and (5) approving or denying the security check request.

To compare the user's facial gesture with the desired facial gesture, an example technique includes using data structures as bitmap or vectors for computation. For example, a 3-digit vector may be used to represent a facial gesture in a scheme that considers eye wink, mouth opening, and head tilting perspectives. For the eye wink perspective, no eye wink is defined as 0, left eye wink is defined as 1, and right eye wink is defined as 2 Similarly, for the mouth aspect, mouth shut is 0 and mouth open is 1; and for head tilt, no head tilting is 0, while head tilting to left be 1 and to right be 2. Thus, when the prompt is “right eye wink, open mouth, and tilting head to left,” the corresponding 3-digit vector may be mapped as <211>. After analyzing the user's performing facial gesture, a result bitmap is obtained, e.g., <212>. By vector comparison computation, the system draws a conclusion that the user failed the verification. More or fewer digits may be used in a facial gesture vector. In addition, the presently disclosed system may be extended to include more classified facial gestures (e.g., additional mouth gestures as smile, frown, neutral, etc.; additional nose, eyebrow, ear, or head movement gestures, etc.).

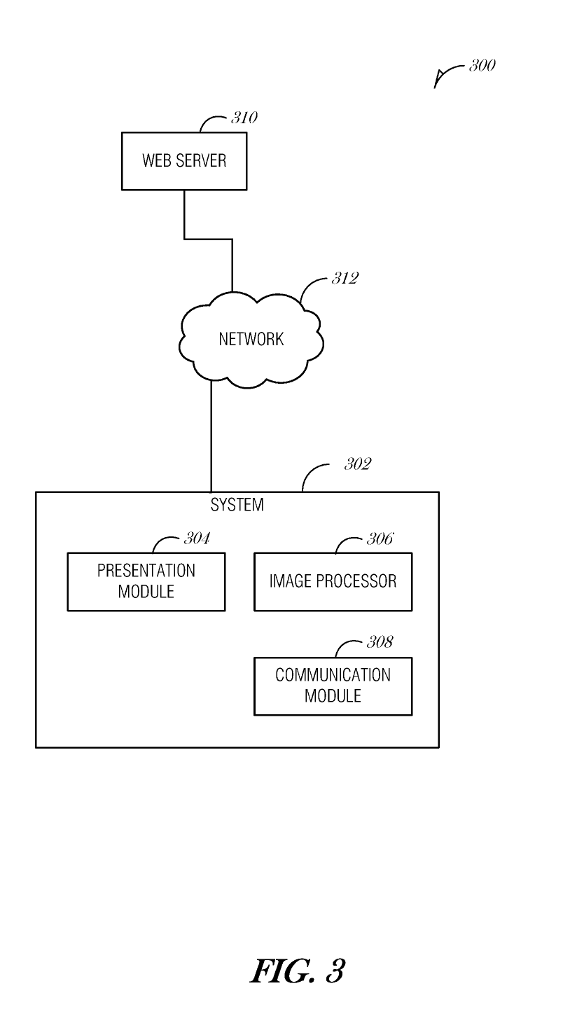

FIG. 3 is a schematic diagram illustrating an operating environment 300, according to an embodiment. A system 302 for securing a resource includes a presentation module 304, an image processor 306, and a communication module 308. The resource may be electronic content, for example, a web page, a web site, a download, a movie, an application, a music file, or other digital content. The resource may be served from a server (e.g., web server 310) over a network 314 to the system 302. The network 312 may include various wired or wireless connections over various protocols or transmission media, such as IEEE 802.11 Wi-Fi, Bluetooth, cellular communications, or the like.

The presentation module 304 may be configured to present on a display of the system 302, a facial gesture challenge prompt to a user. In an embodiment, the facial gesture challenge prompt comprises a eye expression. In a further embodiment, the eye expression comprises a wink using a single eye of a pair of eyes. In another embodiment, the eye expression comprises a squint of a pair of eyes. In an embodiment, the facial gesture challenge prompt comprises a mouth expression. In a further embodiment, the mouth expression comprises a smile. In another embodiment, the mouth expression comprises a wide open mouth, such as when making an “ahh” sound or yawning. In an embodiment, the facial gesture challenge prompt comprises a head tilt.

Multiple facial expressions may be used together in the facial gesture. Thus, in an embodiment, the facial gesture challenge prompt comprises a combination of at least two expressions from the group of expressions of: an eye expression, a mouth expression, and a head tilt.

As discussed above, the facial gesture challenge may be provided in various forms. In an embodiment, the facial gesture challenge prompt is textual. A text-based facial gesture challenge prompt may be an image with text that is obscured or deformed to prevent easy computer-based recognition. In another embodiment, the facial gesture challenge prompt is a pictograph. A pictograph may be an icon, drawing, illustration, photo, or other graphical form to provide a desired facial gesture to the user. A pictograph has an advantage of being language agnostic. The facial gesture challenge prompt may be provided with an audio que, such as a spoken directive. Such an embodiment may be useful for those who have vision impairments.

The image processor 306 may be configured to obtain an image from a camera coupled to the compute device, the image including a facial expression of the user. In an embodiment, the camera comprises a depth camera. The camera may be operable to build a three-dimensional model of the user's face and analyze the model for expressions.

The image processor 306 may also be configured to obtain analysis of the image, the analysis to determine whether the facial expression matches the facial gesture challenge prompt. In an embodiment, to obtain the image, the image processor 3065 is to receive a trigger action from the user and capture the image of the facial expression in response to the trigger action. The trigger action may be a user interface element activation, such as when a user clicks on a form submit button.

In an embodiment, to obtain analysis of the image, the image processor 306 is to detect a set of landmarks in the image, the landmarks corresponding to facial features; create a coordinate model; and determine the facial expression based on landmark distribution in the coordinate model. The landmarks may be various features found on a face, such as the corners or edges of the eyes, the point of the nose, the corners or edges of the lips, the bridge of the nose, the points of the cheeks, the edges of the eyebrows, and the like. The coordinate model may segment the face into four quadrants, where the face is roughly separated into fourths. By looking at the landmark distribution in a certain quadrant, the analysis may determine whether a user's left eye or right eye is in an open or closed state, for example.

While some embodiments include local (e.g., at the system) image processing to detect the user's face and determine the user's facial gesture, in other embodiments, the image of the user's face is transmitting to a remote server (e.g., web server 310) for processing. Thus, in an embodiment, to obtain the analysis of the image, the image processor 306 is to interface with a communication module 308 to transmit the image to a remote computing service (e.g., web server 310) that is configured to: detect a set of landmarks in the image, the landmarks corresponding to facial features; create a coordinate model; determine the facial expression based on landmark distribution in the coordinate model; and respond to the system with the analysis of the image. The response may be to navigate the user to a new page, initiate a download of a digital file, or the like.

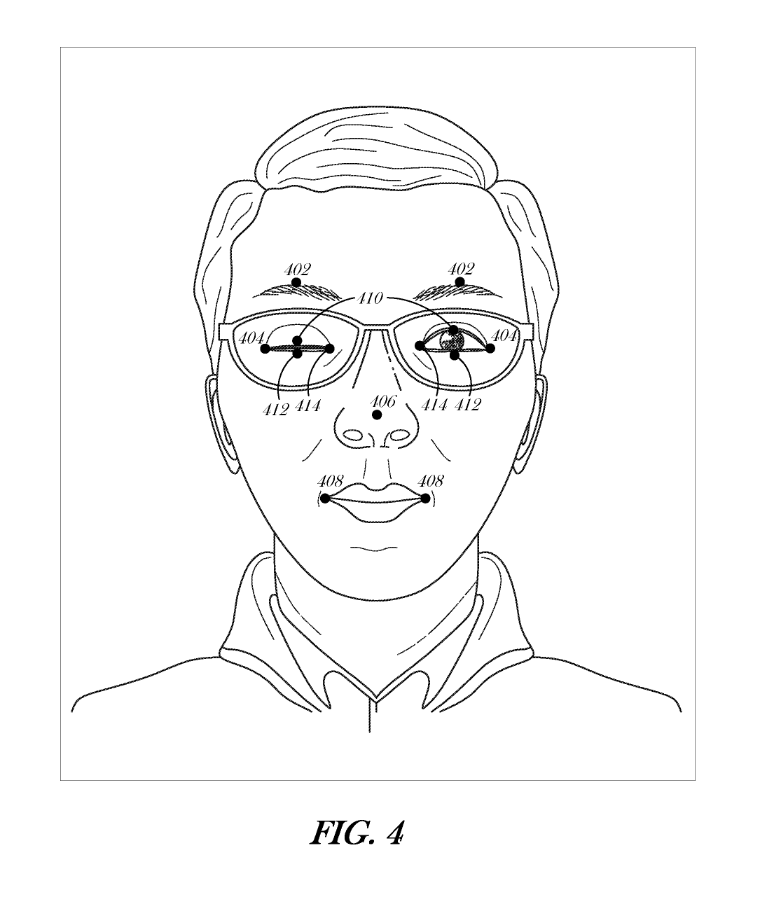

FIG. 4 is an illustration of a coordinate model, according to an embodiment. A face 400 includes multiple landmark points, including points on an eyebrow 402 (e.g., middle of brow), an eye 404 (e.g., outer edge of eye), a nose 406 (e.g., tip of nose), and a mouth 408 (e.g., outside edges of mouth). Although only a few landmark points are illustrated in FIG. 4, it is understood that many more may be present and used by facial analysis programs to determine landmark position. Examples of additional landmarks include, but are not limited to an outer edge of brow, middle of brow, inner edge of brow, outside edge of eye, midpoints on eye, inside edge of eye, bridge of nose, lateral sides of nose, tip of nose, outside edges of mouth, left and right medial points on upper lip, center of upper lip, left and right medial points on lower lip.

Based on the position of the landmarks (e.g., 402, 404, 406, 408, etc.) or the position over time of the landmarks, a facial expression may be determined. For example, a sequence of facial expressions may be recognized and detected as a specific movement pattern of the landmarks. In another example, using a density of landmark points in an area of the face 400 between the eyebrows including the forehead, it may be determined that the face shows a particular expression (e.g., surprise). In another example, both a distance between landmark points and a density of landmark points in an area may be used to determine an expression classification. For example, determining an expression classification of a smile may include determining a distance between the eye point 404 and the eyebrow point 402 as well as a density of landmark points around the eyes, e.g., points 410, 412, and 414. In the example illustrated in FIG. 4, the density and distribution of landmarks around the face's right eye indicate that the eye is closed, while the density and distribution of landmarks around the left eye indicate that the eye is open. As such, the image processor 306 may determine that the expression includes a “wink.”

The presentation module 304 may be configured to provide an indication to the user of whether the facial expression matches the facial gesture challenge prompt. In an embodiment, to provide the indication to the user, the presentation module 304 is to provide a second facial gesture challenge prompt to the user when the facial expression does not match the facial gesture challenge prompt. Thus, when a user fails the CAPTCHA test, the user may be given another chance. The user may be limited to a certain number of chances (e.g., five) in order to curb potential abuse or hacking of the system 302.

In an embodiment, to provide the indication to the user, the presentation module 304 is to navigate the user to the secured resource when the facial expression does match the facial gesture challenge prompt. For example, the presentation module 304 may initiate navigation to another web page, initiate the download of a digital file, or the like.

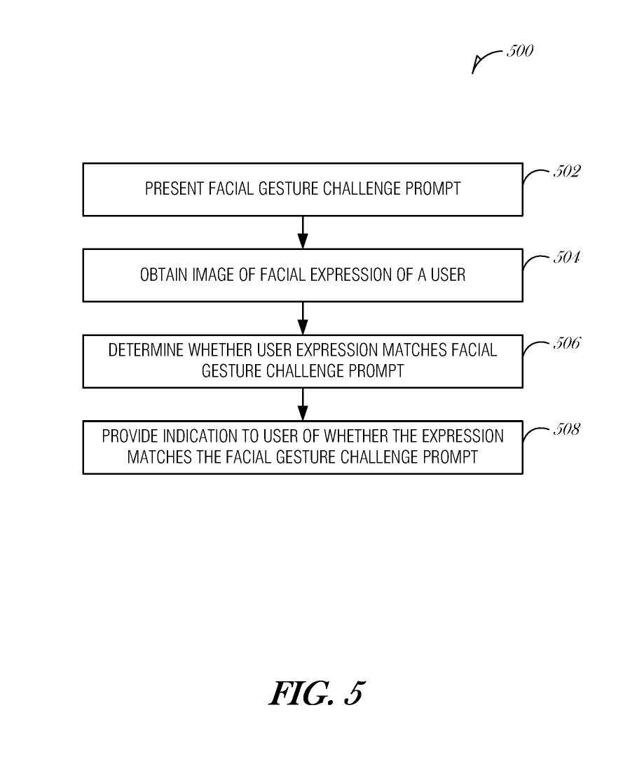

FIG. 5 is a flowchart illustrating a method 500 of securing a resource, according to an embodiment. At block 502, a facial gesture challenge prompt to a user is presented on a display of a compute device. In an embodiment, the facial gesture challenge prompt comprises a eye expression. In a further embodiment, the eye expression comprises a wink using a single eye of a pair of eyes. In another embodiment, the eye expression comprises a squint of a pair of eyes.

In an embodiment, the facial gesture challenge prompt comprises a mouth expression. In a further embodiment, the mouth expression comprises a smile. In another embodiment, the mouth expression comprises a wide open mouth.

In an embodiment, the facial gesture challenge prompt comprises a head tilt.

In an embodiment, the facial gesture challenge prompt is textual. In another embodiment, the facial gesture challenge prompt is a pictograph.

In an embodiment, the facial gesture challenge prompt comprises a combination of at least two expressions from the group of expressions of: an eye expression, a mouth expression, and a head tilt.

At block 504, an image is obtained from a camera coupled to the compute device, the image including a facial expression of the user. In an embodiment, the camera comprises a depth camera. In an embodiment, obtaining the image comprises receiving a trigger action from the user and capturing the image of the facial expression in response to the trigger action.

At block 506, the image is analyzed to determine whether the facial expression matches the facial gesture challenge prompt. In an embodiment, analyzing the image comprises detecting a set of landmarks in the image, the landmarks corresponding to facial features; creating a coordinate model and determining the facial expression based on landmark distribution in the coordinate model.

In an embodiment, analyzing the image comprises transmitting the image to a remote server for analysis, the analysis including: detecting a set of landmarks in the image, the landmarks corresponding to facial features; creating a coordinate model; and determining the facial expression based on landmark distribution in the coordinate model.

At block 508, an indication is provided to the user of whether the facial expression matches the facial gesture challenge prompt. In an embodiment, providing the indication to the user comprises providing a second facial gesture challenge prompt to the user when the facial expression does not match the facial gesture challenge prompt.

In another embodiment, providing the indication to the user comprises navigating the user to the secured resource when the facial expression does match the facial gesture challenge prompt.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the machine-readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

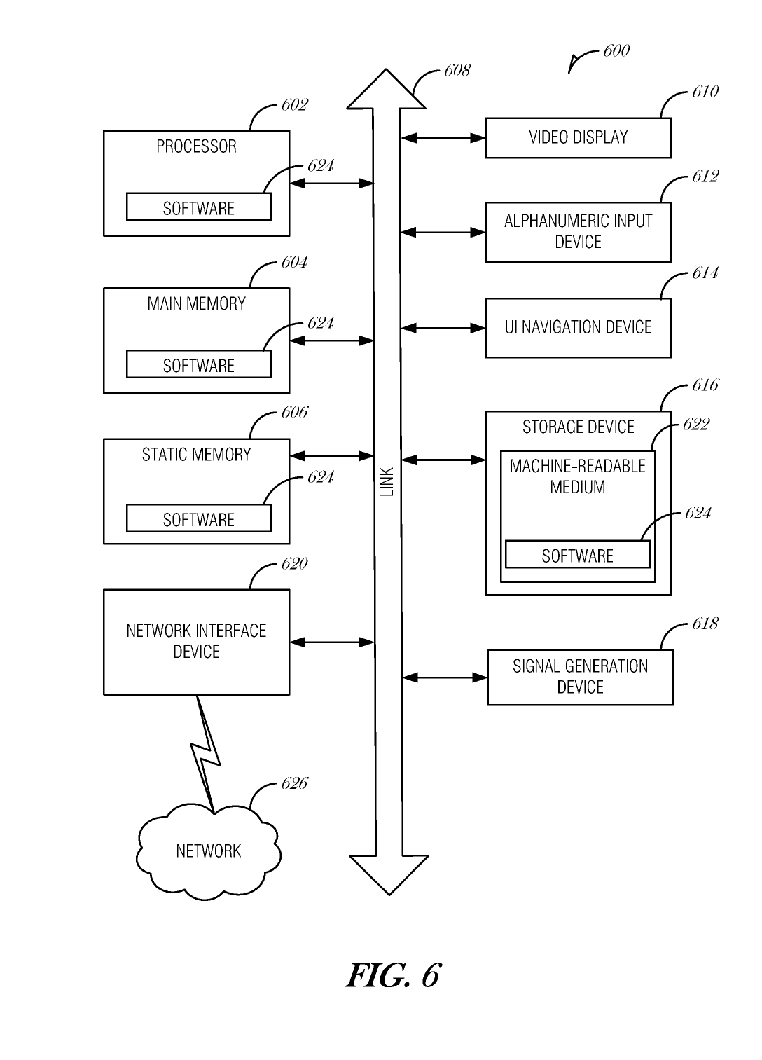

FIG. 6 is a block diagram illustrating a machine in the example form of a computer system 600, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 600 includes at least one processor 602 (e.g., a central processing unit (CPU), a graphics processing unit (GPU) or both, processor cores, compute nodes, etc.), a main memory 604 and a static memory 606, which communicate with each other via a link 608 (e.g., bus). The computer system 600 may further include a video display unit 610, an alphanumeric input device 612 (e.g., a keyboard), and a user interface (UI) navigation device 614 (e.g., a mouse). In one embodiment, the video display unit 610, input device 612 and UI navigation device 614 are incorporated into a touch screen display. The computer system 600 may additionally include a storage device 616 (e.g., a drive unit), a signal generation device 618 (e.g., a speaker), a network interface device 620, and one or more sensors (not shown), such as a global positioning system (GPS) sensor, compass, accelerometer, or other sensor.

The storage device 616 includes a machine-readable medium 622 on which is stored one or more sets of data structures and instructions 624 (e.g., software) embodying or utilized by any one or more of the methodologies or functions described herein. The instructions 624 may also reside, completely or at least partially, within the main memory 604, static memory 606, and/or within the processor 602 during execution thereof by the computer system 600, with the main memory 604, static memory 606, and the processor 602 also constituting machine-readable media.

While the machine-readable medium 622 is illustrated in an example embodiment to be a single medium, the term “machine-readable medium” may include a single medium or multiple media (e.g., a centralized or distributed database, and/or associated caches and servers) that store the one or more instructions 624. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### ADDITIONAL NOTES & EXAMPLES

Example 1 is a system for securing a resource, the system comprising: a presentation module to present on a display of the system, a facial gesture challenge prompt to a user; an image processor to: obtain an image from a camera coupled to the compute device, the image including a facial expression of the user; and obtain analysis of the image, the analysis to determine whether the facial expression matches the facial gesture challenge prompt; and wherein the presentation module is to provide an indication to the user of whether the facial expression matches the facial gesture challenge prompt.

In Example 2, the subject matter of Example 1 optionally includes, wherein the facial gesture challenge prompt comprises a eye expression.

In Example 3, the subject matter of Example 2 optionally includes, wherein the eye expression comprises a wink using a single eye of a pair of eyes.

In Example 4, the subject matter of any one or more of Examples 2-3 optionally include, wherein the eye expression comprises a squint of a pair of eyes.

In Example 5, the subject matter of Example 1 optionally includes, wherein the facial gesture challenge prompt comprises a mouth expression.

In Example 6, the subject matter of Example 5 optionally includes, wherein the mouth expression comprises a smile.

In Example 7, the subject matter of any one or more of Examples 5-6 optionally include, wherein the mouth expression comprises a wide open mouth.

In Example 8, the subject matter of any one or more of Examples 1-7 optionally include, wherein the facial gesture challenge prompt comprises a head tilt.

In Example 9, the subject matter of any one or more of Examples 1-8 optionally include, wherein the facial gesture challenge prompt comprises a combination of at least two expressions from the group of expressions of: an eye expression, a mouth expression, and a head tilt.

In Example 10, the subject matter of any one or more of Examples 1-9 optionally include, wherein the facial gesture challenge prompt is textual.

In Example 11, the subject matter of any one or more of Examples 1-10 optionally include, wherein the facial gesture challenge prompt is a pictograph.

In Example 12, the subject matter of any one or more of Examples 1-11 optionally include, wherein to obtain the image, the image processor is to: receive a trigger action from the user; and capture the image of the facial expression in response to the trigger action.

In Example 13, the subject matter of any one or more of Examples 1-12 optionally include, wherein the camera comprises a depth camera.

In Example 14, the subject matter of any one or more of Examples 1-13 optionally include, wherein to obtain analysis of the image, the image processor is to: detect a set of landmarks in the image, the landmarks corresponding to facial features; create a coordinate model; and determine the facial expression based on landmark distribution in the coordinate model.

In Example 15, the subject matter of any one or more of Examples 1-14 optionally include, wherein to obtain the analysis of the image, the image processor is to interface with a communication module to: transmit the image to a remote computing service that is configured to: detect a set of landmarks in the image, the landmarks corresponding to facial features; create a coordinate model; determine the facial expression based on landmark distribution in the coordinate model; and respond to the system with the analysis of the image.

In Example 16, the subject matter of any one or more of Examples 1-15 optionally include, wherein to provide the indication to the user, the presentation module is to provide a second facial gesture challenge prompt to the user when the facial expression does not match the facial gesture challenge prompt.

In Example 17, the subject matter of any one or more of Examples 1-16 optionally include, wherein to provide the indication to the user, the presentation module is to navigate the user to the secured resource when the facial expression does match the facial gesture challenge prompt.

Example 18 is a method of securing a resource, the method comprising: presenting on a display of a compute device, a facial gesture challenge prompt to a user; obtaining an image from a camera coupled to the compute device, the image including a facial expression of the user; analyzing the image to determine whether the facial expression matches the facial gesture challenge prompt; and providing an indication to the user of whether the facial expression matches the facial gesture challenge prompt.

In Example 19, the subject matter of Example 18 optionally includes, wherein the facial gesture challenge prompt comprises a eye expression.

In Example 20, the subject matter of Example 19 optionally includes, wherein the eye expression comprises a wink using a single eye of a pair of eyes.

In Example 21, the subject matter of any one or more of Examples 19-20 optionally include, wherein the eye expression comprises a squint of a pair of eyes.

In Example 22, the subject matter of any one or more of Examples 18-21 optionally include, wherein the facial gesture challenge prompt comprises a mouth expression.

In Example 23, the subject matter of Example 22 optionally includes, wherein the mouth expression comprises a smile.

In Example 24, the subject matter of any one or more of Examples 22-23 optionally include, wherein the mouth expression comprises a wide open mouth.

In Example 25, the subject matter of any one or more of Examples 18-24 optionally include, wherein the facial gesture challenge prompt comprises a head tilt.

In Example 26, the subject matter of any one or more of Examples 18-25 optionally include, wherein the facial gesture challenge prompt comprises a combination of at least two expressions from the group of expressions of: an eye expression, a mouth expression, and a head tilt.

In Example 27, the subject matter of any one or more of Examples 18-26 optionally include, wherein the facial gesture challenge prompt is textual.

In Example 28, the subject matter of any one or more of Examples 18-27 optionally include, wherein the facial gesture challenge prompt is a pictograph.

In Example 29, the subject matter of any one or more of Examples 18-28 optionally include, wherein obtaining the image comprises: receiving a trigger action from the user; and capturing the image of the facial expression in response to the trigger action.

In Example 30, the subject matter of any one or more of Examples 18-29 optionally include, wherein the camera comprises a depth camera.

In Example 31, the subject matter of any one or more of Examples 18-30 optionally include, wherein analyzing the image comprises: detecting a set of landmarks in the image, the landmarks corresponding to facial features; creating a coordinate model; and determining the facial expression based on landmark distribution in the coordinate model.

In Example 32, the subject matter of any one or more of Examples 18-31 optionally include, wherein analyzing the image comprises: transmitting the image to a remote server for analysis, the analysis including: detecting a set of landmarks in the image, the landmarks corresponding to facial features; creating a coordinate model; and determining the facial expression based on landmark distribution in the coordinate model.

In Example 33, the subject matter of any one or more of Examples 18-32 optionally include, wherein providing the indication to the user comprises providing a second facial gesture challenge prompt to the user when the facial expression does not match the facial gesture challenge prompt.

In Example 34, the subject matter of any one or more of Examples 18-33 optionally include, wherein providing the indication to the user comprises navigating the user to the secured resource when the facial expression does match the facial gesture challenge prompt.

Example 35 is at least one machine-readable medium including instructions, which when executed by a machine, cause the machine to perform operations of any of the methods of Examples 18-34.

Example 36 is an apparatus comprising means for performing any of the methods of Examples 18-34.

Example 37 is an apparatus for securing a resource, the apparatus comprising: means for presenting on a display of a compute device, a facial gesture challenge prompt to a user; means for obtaining an image from a camera coupled to the compute device, the image including a facial expression of the user; means for analyzing the image to determine whether the facial expression matches the facial gesture challenge prompt; and means for providing an indication to the user of whether the facial expression matches the facial gesture challenge prompt.

In Example 38, the subject matter of Example 37 optionally includes, wherein the facial gesture challenge prompt comprises a eye expression.

In Example 39, the subject matter of Example 38 optionally includes, wherein the eye expression comprises a wink using a single eye of a pair of eyes.

In Example 40, the subject matter of any one or more of Examples 38-39 optionally include, wherein the eye expression comprises a squint of a pair of eyes.

In Example 41, the subject matter of any one or more of Examples 37-40 optionally include, wherein the facial gesture challenge prompt comprises a mouth expression.

In Example 42, the subject matter of Example 41 optionally includes, wherein the mouth expression comprises a smile.

In Example 43, the subject matter of any one or more of Examples 41-42 optionally include, wherein the mouth expression comprises a wide open mouth.

In Example 44, the subject matter of any one or more of Examples 37-43 optionally include, wherein the facial gesture challenge prompt comprises a head tilt.

In Example 45, the subject matter of any one or more of Examples 37-44 optionally include, wherein the facial gesture challenge prompt comprises a combination of at least two expressions from the group of expressions of: an eye expression, a mouth expression, and a head tilt.

In Example 46, the subject matter of any one or more of Examples 37-45 optionally include, wherein the facial gesture challenge prompt is textual.

In Example 47, the subject matter of any one or more of Examples 37-46 optionally include, wherein the facial gesture challenge prompt is a pictograph.

In Example 48, the subject matter of any one or more of Examples 37-47 optionally include, wherein the means for obtaining the image comprises: means for receiving a trigger action from the user; and means for capturing the image of the facial expression in response to the trigger action.

In Example 49, the subject matter of any one or more of Examples 37-48 optionally include, wherein the camera comprises a depth camera.

In Example 50, the subject matter of any one or more of Examples 37-49 optionally include, wherein the means for analyzing the image comprises: means for detecting a set of landmarks in the image, the landmarks corresponding to facial features; means for creating a coordinate model; and means for determining the facial expression based on landmark distribution in the coordinate model.

In Example 51, the subject matter of any one or more of Examples 37-50 optionally include, wherein the means for analyzing the image comprises: means for transmitting the image to a remote server for analysis, the analysis including: detecting a set of landmarks in the image, the landmarks corresponding to facial features; creating a coordinate model; and determining the facial expression based on landmark distribution in the coordinate model.

In Example 52, the subject matter of any one or more of Examples 37-51 optionally include, wherein the means for providing the indication to the user comprises means for providing a second facial gesture challenge prompt to the user when the facial expression does not match the facial gesture challenge prompt.

In Example 53, the subject matter of any one or more of Examples 37-52 optionally include, wherein the means for providing the indication to the user comprises means for navigating the user to the secured resource when the facial expression does match the facial gesture challenge prompt.

Example 54 is a system for securing a resource, the system comprising: a display; a camera; a processor subsystem; a memory including instructions, which when executed by the processor subsystem, cause the processor subsystem to: present on the display a facial gesture challenge prompt to a user; obtain an image from the camera, the image including a facial expression of the user; obtain analysis of the image, the analysis to determine whether the facial expression matches the facial gesture challenge prompt; and provide an indication to the user of whether the facial expression matches the facial gesture challenge prompt on the display.

In Example 55, the subject matter of Example 54 optionally includes, wherein the facial gesture challenge prompt comprises a eye expression.

In Example 56, the subject matter of Example 55 optionally includes, wherein the eye expression comprises a wink using a single eye of a pair of eyes.

In Example 57, the subject matter of any one or more of Examples 55-56 optionally include, wherein the eye expression comprises a squint of a pair of eyes.

In Example 58, the subject matter of any one or more of Examples 54-57 optionally include, wherein the facial gesture challenge prompt comprises a mouth expression.

In Example 59, the subject matter of Example 58 optionally includes, wherein the mouth expression comprises a smile.

In Example 60, the subject matter of any one or more of Examples 58-59 optionally include, wherein the mouth expression comprises a wide open mouth.

In Example 61, the subject matter of any one or more of Examples 54-60 optionally include, wherein the facial gesture challenge prompt comprises a head tilt.

In Example 62, the subject matter of any one or more of Examples 54-61 optionally include, wherein the facial gesture challenge prompt comprises a combination of at least two expressions from the group of expressions of: an eye expression, a mouth expression, and a head tilt.

In Example 63, the subject matter of any one or more of Examples 54-62 optionally include, wherein the facial gesture challenge prompt is textual.

In Example 64, the subject matter of any one or more of Examples 54-63 optionally include, wherein the facial gesture challenge prompt is a pictograph.

In Example 65, the subject matter of any one or more of Examples 54-64 optionally include, wherein the instructions to obtain the image comprise instructions to: receive a trigger action from the user; and capture the image of the facial expression in response to the trigger action.

In Example 66, the subject matter of any one or more of Examples 54-65 optionally include, wherein the camera comprises a depth camera.

In Example 67, the subject matter of any one or more of Examples 54-66 optionally include, wherein the instructions to obtain the analysis of the image comprise instructions to: detect a set of landmarks in the image, the landmarks corresponding to facial features; create a coordinate model; and determine the facial expression based on landmark distribution in the coordinate model.

In Example 68, the subject matter of any one or more of Examples 54-67 optionally include, wherein the instructions to obtain the analysis of the image comprise instructions to: transmit the image to a remote computing service that is configured to: detect a set of landmarks in the image, the landmarks corresponding to facial features; create a coordinate model; determine the facial expression based on landmark distribution in the coordinate model; and respond to the system with the analysis of the image.

In Example 69, the subject matter of any one or more of Examples 54-68 optionally include, wherein the instructions to provide the indication to the user comprise instructions to provide a second facial gesture challenge prompt to the user when the facial expression does not match the facial gesture challenge prompt.

In Example 70, the subject matter of any one or more of Examples 54-69 optionally include, wherein the instructions to provide the indication to the user comprise instructions to navigate the user to the secured resource when the facial expression does match the facial gesture challenge prompt.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1.-25. (canceled)

26. A system for securing a resource, the system comprising:
a presentation module to present on a display of the system, a facial gesture challenge prompt to a user;
an image processor to:
obtain an image from a camera coupled to the compute device, the image including a facial expression of the user; and
obtain analysis of the image, the analysis to determine whether the facial expression matches the facial gesture challenge prompt; and
wherein the presentation module is to provide an indication to the user of whether the facial expression matches the facial gesture challenge prompt.

27. The system of claim 26, wherein the facial gesture challenge prompt comprises a eye expression.

28. The system of claim 26, wherein the facial gesture challenge prompt comprises a mouth expression.

29. The system of claim 26, wherein the facial gesture challenge prompt comprises a combination of at least two expressions from the group of expressions of: an eye expression, a mouth expression, and a head tilt.

30. The system of claim 26, wherein the facial gesture challenge prompt is textual.

31. The system of claim 26, wherein the facial gesture challenge prompt is a pictograph.

32. The system of claim 26, wherein obtain the image, the image processor is to:
receive a trigger action from the user; and
capture the image of the facial expression in response to the trigger action.

33. The system of claim 26, wherein the camera comprises a depth camera.

34. The system of claim 26, wherein to obtain analysis of the image, the image processor is to:
detect a set of landmarks in the image, the landmarks corresponding to facial features;
create a coordinate model; and
determine the facial expression based on landmark distribution in the coordinate model.

35. The system of claim 26, wherein to obtain the analysis of the image, the image processor is to interface with a communication module to:
transmit the image to a remote computing service that is configured to:
detect a set of landmarks in the image, the landmarks corresponding to facial features;
create a coordinate model;
determine the facial expression based on landmark distribution in the coordinate model; and
respond to the system with the analysis of the image.

36. The system of claim 26, wherein to provide the indication to the user, the presentation module is to provide a second facial gesture challenge prompt to the user when the facial expression does not match the facial gesture challenge prompt.

37. The system of claim 26, wherein to provide the indication to the user, the presentation module is to navigate the user to the secured resource when the facial expression does match the facial gesture challenge prompt.

38. A system for securing a resource, the system comprising:
a display;
a camera;
a processor subsystem;
a memory including instructions, which when executed by the processor subsystem, cause the processor subsystem to:
present on the display a facial gesture challenge prompt to a user;
obtain an image from the camera, the image including a facial expression of the user;
obtain analysis of the image, the analysis to determine whether the facial expression matches the facial gesture challenge prompt; and
provide an indication to the user of whether the facial expression matches the facial gesture challenge prompt on the display.

39. The system of claim 38, wherein the facial gesture challenge prompt is a pictograph.

40. The system of claim 38, wherein the instructions to obtain the analysis of the image comprise instructions to:
detect a set of landmarks in the image, the landmarks corresponding to facial features;
create a coordinate model; and
determine the facial expression based on landmark distribution in the coordinate model.

41. At least one machine-readable medium including instructions, which when executed by a machine, cause the machine to perform operations of:
presenting on a display of a compute device, a facial gesture challenge prompt to a user;
obtaining an image from a camera coupled to the compute device, the image including a facial expression of the user;
analyzing the image to determine whether the facial expression matches the facial gesture challenge prompt; and
providing an indication to the user of whether the facial expression matches the facial gesture challenge prompt.

42. The at least one machine-readable medium of claim 41, wherein the instructions for analyzing the image comprise instructions, which when executed by the machine, cause the machine to perform the operations of:
detecting a set of landmarks in the image, the landmarks corresponding to facial features;
creating a coordinate model; and
determining the facial expression based on landmark distribution in the coordinate model.

43. A method of securing a resource, the method comprising:
presenting on a display of a compute device, a facial gesture challenge prompt to a user;
obtaining an image from a camera coupled to the compute device, the image including a facial expression of the user;
analyzing the image to determine whether the facial expression matches the facial gesture challenge prompt; and
providing an indication to the user of whether the facial expression matches the facial gesture challenge prompt.

44. The method of claim 43, wherein the facial gesture challenge prompt comprises a eye expression.

45. The method of claim 43, wherein the facial gesture challenge prompt comprises a combination of at least two expressions from the group of expressions of: an eye expression, a mouth expression, and a head tilt.

46. The method of claim 43, wherein the facial gesture challenge prompt is textual.

47. The method of claim 43, wherein the facial gesture challenge prompt is a pictograph.

48. The method of claim 43, wherein obtaining the image comprises:
receiving a trigger action from the user; and
capturing the image of the facial expression in response to the trigger action.

49. The method of claim 43, wherein the camera comprises a depth camera.

50. The method of claim 43, wherein analyzing the image comprises:
detecting a set of landmarks in the image, the landmarks corresponding to facial features;
creating a coordinate model; and
determining the facial expression based on landmark distribution in the coordinate model.

51. The method of claim 43, wherein providing the indication to the user comprises providing a second facial gesture challenge prompt to the user when the facial expression does match the facial gesture challenge prompt.
